(19) United States
(12) Patent Application Publication
(10) Pub. No.: US 2003/0103345 A1
(43) Pub. Date: Jun. 5, 2003

(54) High lumen LED solar sign

(76) Inventor: Steven T. Nolan, Beaumont, TX (US)

Correspondence Address: RANDAL D. HOBURG, P. O. BOX 10470, MIDWEST CITY, OK, 73140-1470, US

(21) Appl. No.: 10/002,898

(22) Filed: Dec. 5, 2001

(51) Int. Cl. F21L 2/00

(52) U.S. Cl. 362/157

(57) ABSTRACT

The invention is a self-contained solar powered back lighted sign using low voltage bright white LED lamps for a light source, the device comprising a sign encasement, an internal bright white LED light source, at least one white translucent dispersion panel, sign display medium, at least one transparent front panel, an internal rechargeable battery supply, electrical circuitry, a photo sensor and an at least one external solar generating unit. Plain white paper signs, transparencies and changeable lettering may by displayed in this device, providing for repeated low-cost change of the display medium on the device, the device being perpetual and self-contained providing its own cost-free electrical energy.

### CROSS REFERENCE TO RELATED APPLICATIONS

None

### I. Background of the Invention

1. Field of Invention

The invention is a self-contained solar powered back-lighted sign using low voltage bright white LED lamps for a light source, including a sign encasement, an internal bright white LED light source, one or more white translucent dispersion panel, sign display medium, one or more transparent front panel, an internal rechargeable battery supply, electrical circuitry, a photo sensor and an at least one external solar generating unit. Plain white paper signs, transparencies and changeable lettering may by displayed in this device, providing for repeated low-cost change of the display medium on the device, the device being perpetual and self-contained providing its own cost-free electrical energy.

2. Description of Prior Art

The following United States patents were discovered and are disclosed within this application for utility patent. All relate to outdoor signs. A first sign is disclosed in U.S. Pat. No. 6,263,601 to Emert which has a solar charging cell, a photocell, rechargeable batteries and a singular translucent surface upon which sign logo is attached to the translucent surface, the sign mounted on a locking mounting bracket affixed to the real property.

In U.S. Pat. No. 6,004,002 to Giannone, a lighted sign is supplied power through a remote solar power supply with a battery, connecting to the sign by a buried power cable. U.S. Pat. No. 5,729,924 to Reading discloses an illuminated sign with two transparent panels between which is mounted a sign, such sign powered by a fluorescent light tube connected to a battery charged by a solar cell. A realty sign having a solar cell providing power to illuminate a sign hanging under the light source is disclosed in U.S. Pat. No. 5,101,329 to Doyle. A solar powered housing address indicating device is disclosed in U.S. Pat. No. 5,007,190 to Shyu, the sign having a digital LED device with a control setting to preset a series of number corresponding to the house address and a road name indicating strip.

### II. SUMMARY OF THE INVENTION

The primary objective of the invention is to provide a solar powered sign using bright white LED lamps behind a white translucent dispersion panel whereupon transparent signage, plain white paper signs or lettering may be displayed where there is no power available, the bright white LED lamps providing advantages over other conventional lighting by requiring low voltage, giving off little or no heat and having a life span of over 100,000 hours.

Almost every prior art patent requires the image to be displayed to be imprinted or laminated onto clear plastic material or a surface which is located directly in front of light bulbs. This generally requires use of a professional print shop, which is generally not available for home production or use. Printers and copiers are not equipped with white ink. In order for an image printed with an ordinary printer or copier to be displayed, the sections which are white are transferred onto this medium as clear. When the light is directed through this display medium, the image seen is severely distorted by the direct unfiltered light through the clear portion of the image being displayed. Ordinary copy paper cannot be used, because it tends to become dark and images printed in dark color on this medium tend to lose their color because of the density of the ink in contrast to lighter colors.

The present invention, in using the white translucent display panel between the high lumen light source and the display image allows for production of display medium using a simple home computer printer on white paper or simple low-cost print shop technique. The white translucent display panel evenly disperses the light from the high lumen light source and also maintains the integrity of the colors. White actually appears white and is of an even intensity, reducing bright spots through the display medium. Colors experience less darkening and distortion due to the white translucent display panel maintaining a uniform light dispersion back-lighted image. Childrens artwork, digital photographs on white paper, transparencies or text messages can all be displayed with clear visual accuracy of the printed or displayed subject matter.

LED lighting has several advantages over conventional lighting, including incandescent and fluorescent lighting. With incandescent bulbs, almost 85% of the energy used in the bulb is given off as heat making them quite inefficient as a light source. Due to their design, these bulbs have a very short life span and require frequent replacement. A great deal of lighted device design is concerned with protection from heat or requiring the incorporation of small low wattage low lumen bulbs, due to the excessive heat produced by conventional incandescent bulbs. Conventional incandescent fixtures are designed with concern for heat, bulb replacement access, bulb size and code requirements for 110 volt and 220 volt AC wiring.

With fluorescent lamps, 110 or 220 volt current is still required and they are operated by very expensive ballasts, which do not withstand time or exposure to exterior elements and heat. They are long and cumbersome to replace, and if they explode due to slight contact, they can become quite dangerous, with sharp, flying glass fragments. Fluorescent bulbs generally tend to flicker after a short period of use, which is disturbing to a user. Some fluorescent bulbs are equipped with Edison light bulb attachments, but these are usually bigger than their incandescent replacement subjects and can disrupt the fixture to which they are applied. The ballasts used to operate these bulbs utilize a great deal of power, thereby draining the battery supply stored by the solar collectors, requiring either a large battery supply or very short life of the stored power.

Using the bright white LEDs minimized the amount of required power for operation and prolongs the time the stored energy may be drawn before exhausting the stored power supply. It also makes replacement of the bulbs a non-issue, since these LEDs have a life span of nearly 100 times that of the more conventional lighting bulbs.

Another purpose of the invention is to provide on the invention solar panels which are either located on a variety of surfaces on the device or which are able to be positioned for maximum exposure to available solar energy, charging long life rechargeable batteries which have an extended illumination potential due to the nominal low voltage requirements of the bright white LED lamps used to back-light the white translucent display panel. A solar panel could also be provided which is separate from the sign housing, attached to the sign via a low voltage DC power cord. The cord could be short, so the solar panel is located near the sign, which may allow the user more liberty to position the solar panel facing the optimum exposure placement to the solar source.

### III. DESCRIPTION OF THE DRAWINGS

The following drawings are submitted with this utility patent application.

FIG. 1 is a front view of the invention.

FIG. 2 is a side cross section of the one-sided display embodiment of the invention.

FIG. 3 is a side cross section of the two-sided display embodiment of the invention.

FIG. 4 is a perspective view of the invention with the multiple positioned solar panel.

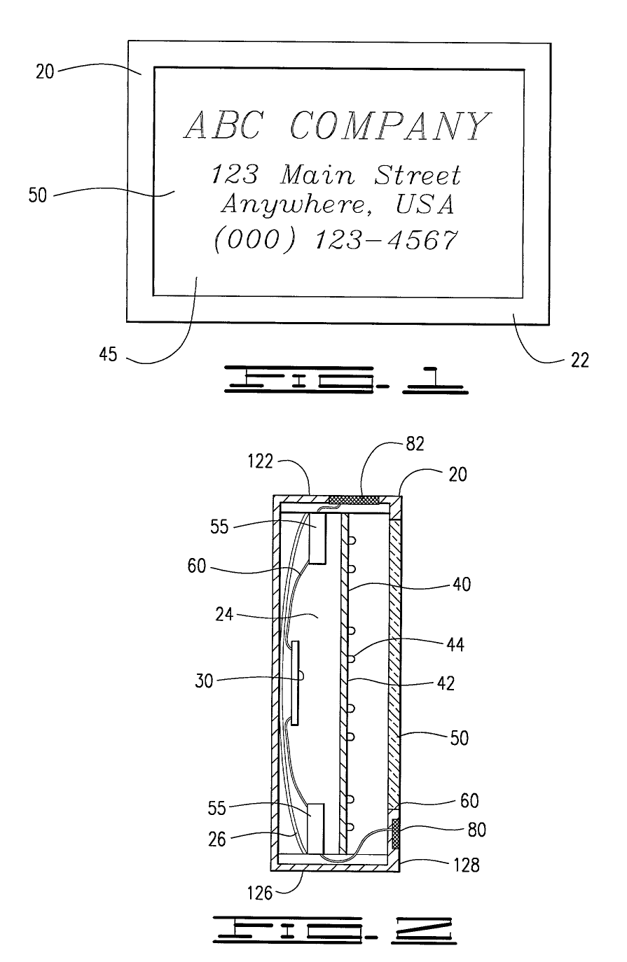

### IV. DESCRIPTION OF THE PREFERRED EMBODIMENT

The invention is a self-contained solar powered back lighted sign using low voltage bright white LED lamps for a light source 10, the device comprising a sign encasement 20, an internal bright white LED light source 30, at least one white translucent dispersion panel 40, sign display medium 45, at least one transparent front panel 50, an internal rechargeable battery supply 55, electrical circuitry 60, a photo sensor 65 and at least one external solar generating unit 80.

In a first embodiment of the device, which is a single-sided display device, the sign encasement 20 has an outer surface 22 and an internal cavity 24 which contains the internal bright white LED light source 30, provided by a plurality of bright white LED lamps 32 set in front of a reflective backing plate 26, the bright white LED lamps 32 producing a high lumen output with low voltage DC power supplied by the internal rechargeable battery supply 55 connected to the plurality of bright white LED lamps 32 by the electrical circuitry 60, as shown in FIG. 2 of the drawings. The internal rechargeable battery supply 55 is connected to the external solar generating unit 80, also through electrical circuitry 60.

The white translucent dispersion panel 40 is positioned in front of the bright white LED light source 30 and the internal rechargeable battery supply 55. This white translucent dispersion panel 40 has a front surface 42 upon which the sign display medium 45 is placed. The transparent front panel 50 is located upon the front surface 42 of the white translucent dispersion panel 40, thus capturing the sign display medium 45 between the white translucent dispersion panel 40 and the transparent front panel 50. A weather tight seal 28 is provided between the sign encasement 20, the white translucent dispersion panel 40 and the transparent front panel 50. Letter brackets 44 may also be provided on the front surface 42 of the white translucent display panel 40 allowing for changeable lettering and numbering to serve as the sign display medium 45.

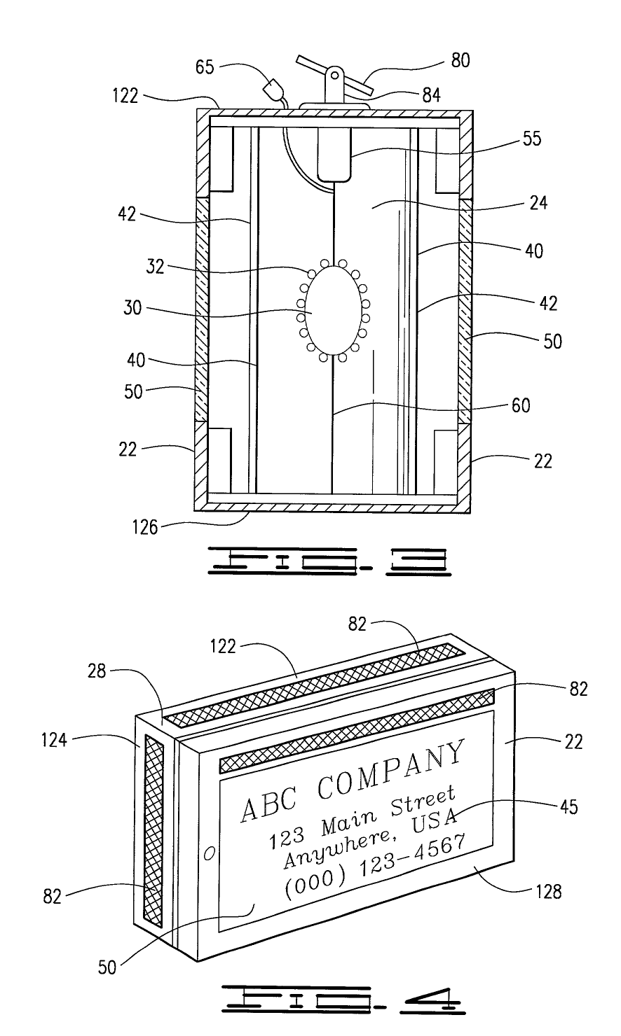

In a second embodiment of the device, as shown in FIG. 3 of the drawings, a two-sided display device is indicated. This two-sided display device also includes a sign encasement 20 having an outer surface 22 and an inner cavity 24. The two-sided display device further includes the bright white LED light source 30, again provided by a plurality of bright white LED lamps 32 producing a high lumen output with low voltage DC power supplied by the internal rechargeable battery supply 55 connected to the bright white LED lamps 32 by the electrical circuitry 60, the internal rechargeable battery supply 55 connected to the external solar generating unit 80, also through electrical circuitry 60.

However, the two-sided display device has two white translucent dispersion panels 40 positioned on opposing sides of the bright white LED light source 30 and the internal rechargeable battery supply 55. Each of these white translucent dispersion panels 30 have a front surface 32 upon which the sign display medium 45 is placed. A transparent front panel 50 is positioned in front of each of the front surfaces 42 of the white translucent dispersion panels 40, thus capturing the sign display medium 45 between the white translucent dispersion panel 40 and the transparent front panel 50 on each side of the two-sided display device. A weather tight seal 28 is provided between the sign encasement 20, the white translucent dispersion panels 40 and the transparent front panels 50. Letter brackets 44 may also be provided on the front surface 42 of each of the white translucent display panels 40 allowing for changeable lettering and numbering to serve as the sign display medium 45.

In both the one-sided display device and the two-sided display device, the photo sensor 65 and the external solar generating unit 80 are located on the outer surface 22 of the sign encasement 20. In a rectangular embodiment of the sign encasement 20, as shown in FIG. 4 of the drawings, the outer surface 22 of the sign encasement may have a top surface 122, two side surfaces 124, a bottom surface 126 and a front surface 128. The photo sensor 65 monitors the available solar supply and regulates the illumination of the bright white LED light source 30, illuminating the bright white LED light source 30 when it is dark and dimming or deactivating the bright white LED light source 32 during daylight periods. This photo sensor 65, alternatively, could be replaced by a timer.

The external solar generating unit 80 may be comprised of a plurality of solar cells 82 located on one or more locations on the outer surface 22. Ideally, the plurality of solar cells 82 would be located on the outer surface 22 where the most sunlight is available, depending on the positioning of the display device. In this sense, it is most preferable that the plurality of the solar cells 82 should exposed primarily to the south. This may be accomplished by positioning the entire device towards the south, where the plurality of solar cells 82 are affixed to the outer surface 22 of the device, or to have the plurality of solar cells 82 moveably mounted on the outer surface 22 of the device wherein the plurality of solar cells 82 may be positioned upwards to the south regardless of the positioning of the device.

In a preferred embodiment, the plurality of solar cells 82 are affixed to the device by a multi-positionable mounting bracket 84, connected to the internal rechargeable battery supply 55 by the electrical circuitry 60, the plurality of solar cells 82 providing the electrical energy stored by the internal rechargeable battery supply 55. Mirrored reflective panels may be mounted around the plurality of solar cells 82 to magnify and amplify the solar energy supply to the plurality of solar cells 82.

The external solar generating unit 80 could also be design to be detachable, attaching to the device with a low voltage DC power cord (not shown). This would enable the user to mount the external solar generating unit 80 to another location not necessarily on the device in order to best position the external solar generating unit 80 for optimum exposure to the solar source.

While the invention has been particularly shown and described with reference to a preferred embodiment thereof, it will be understood by those skilled in the art that changes in form and detail may be made therein without departing from the spirit and scope of the invention.

What is claimed is:

1. A self-contained solar powered back lighted sign using low voltage bright white LED lamps for a light source, the device comprising:
a. a sign encasement;
b. an internal bright white LED light source;
c. at least one white translucent dispersion panel;
d. sign display medium;
e. at least one transparent front panel;
f. an internal rechargeable battery supply;
g. electrical circuitry;
h. a photo sensor; and
i. at least one external solar generating unit.

2. The device as disclosed in claim 2, which is a single-sided display device, further comprising:
a. the sign encasement has an outer surface and an internal cavity which contains the internal bright white LED light source, provided by a plurality of bright white LED lamps set in front of a reflective backing plate, the bright white LED lamps producing a high lumen output with low voltage DC power supplied by the internal rechargeable battery supply connected to the bright white LED lamps by the electrical circuitry;
b. the internal rechargeable battery supply is connected to the external solar generating unit through electrical circuitry;
c. the white translucent dispersion panel is positioned in front of the bright white LED light source and the internal rechargeable battery supply, such white translucent dispersion panel having a front surface upon which the sign display medium is placed;
d. the transparent front panel is positioned in front of the front surface of the white translucent dispersion panel, thus capturing the sign display medium between the white translucent dispersion panel and the transparent front panel; and
e. a weather tight seal is provided between the sign encasement, the white translucent dispersion panel and the transparent front panel.

3. The device, as disclosed in claim 1, which is a two-sided display device, further comprising:
a. the sign encasement having an outer surface and an inner cavity, further including the bright white LED light source provided by a plurality of bright white LED lamps producing a high lumen output with low voltage DC power supplied by the internal rechargeable battery supply connected to the bright white LED lamps by the electrical circuitry, the internal rechargeable battery supply connected to the external solar generating unit, also through electrical circuitry;
b. two white translucent dispersion panels positioned on opposing sides of the bright white LED light source and the internal rechargeable battery supply, each of these white translucent dispersion panels having a front surface upon which the sign display medium is placed;
c. the transparent front panel positioned in front of each of the front surfaces of the white translucent dispersion panels, capturing the sign display medium between the white translucent dispersion panel and the transparent front panel on each side of the two-sided display device; and
d. a weather tight seal provided between the sign encasement, the white translucent dispersion panels and the transparent front panels.

4. The device as disclosed in claim 1, wherein the photo sensor and the external solar generating unit are located on the outer surface of the sign encasement:
a. the photo sensor monitoring the available solar supply and regulating the illumination of the bright white LED light source, illuminating the bright white LED light source when it is dark and dimming or deactivating the bright white LED light source during daylight periods; and
b. external solar generating unit may be comprised of a plurality of solar cells located on one or more locations on the outer surface where the most sunlight is available, depending on the positioning of the display device, such positioning of the plurality of solar cells accomplished by:
1. where the plurality of solar cells are affixed to the display device, positioning the entire device towards the south;
2. the plurality of solar cells moveably mounted on the outer surface of the display device wherein the plurality of solar cells may be positioned upwards to the south regardless of the positioning of the display device;
3. affixing the plurality of solar cells to the display device by a multi-positionable mounting bracket, connected to the internal rechargeable battery supply by the electrical circuitry, the plurality of solar cells providing the electrical energy stored by the internal rechargeable battery supply; and
4. the external solar generating unit is detachable, attaching to the internal rechargeable battery supply, enabling the user to mount the external solar generating unit to another location not on the device in order to best position the external solar generating unit for optimum exposure to the solar source.
